(19) United States
(12) Patent Application Publication
(10) Pub. No.: US 2026/0363463 A1
(43) Pub. Date: Nov. 19, 2026

(54) Decorative Structure Support

(71) Applicant: XIMENEZ CORPORATION 2015, S.L., Puente Genil (ES)

(72) Inventor: Miguel Mariano Jiménez Jiménez, Puente Genil (ES)

(21) Appl. No.: 19/121,902

(22) PCT Filed: Oct. 18, 2023
(86) PCT No.: PCT/EP2023/078974

§ 371 Date: Apr. 17, 2025

(30) Foreign Application Priority Data
Oct. 19, 2022 (EP) 22383004.3

(51) Int. Cl. A47G 1/06

(52) U.S. Cl. CPC A47G 1/0622; A47G 1/065

(57) ABSTRACT

The invention relates to a support especially suitable for holding decorative motifs, for advertising or artistic purposes, with their own lighting, such as those used for embellishment or decoration, both indoors and outdoors. Said support includes two cladding sheets with openwork, which represent a motif, and said sheets are combined with a design of two intermediate layers each arranged overlapping an internal face of each of the cladding sheets. The support also includes at least one attachment element that connects the two cladding sheets and the two intermediate layers in a single rigid framework including a sandwich structure; a lighting element, located inside the rigid framework, and a bead including an opaque section and occupying a section located in the space between the two intermediate layers, being configured to block the passage of light generated by the lighting element from inside the framework to outside said framework.

### CROSS-REFERENCE TO RELATED APPLICATIONS

This application is the United States national phase of International Patent Application No. PCT/EP2023/078974 filed Oct. 18, 2023, and claims priority to European Patent Application No. 22383004.3 filed Oct. 19, 2022, the disclosures of which are hereby incorporated by reference in their entireties.

### BACKGROUND OF THE INVENTION

### Field of the Invention

The object of the present invention consists of a decorative motif support, for advertising or artistic purposes, with its own lighting, used for embellishment or decoration, both indoors and outdoors, especially suitable for use at parties and events, such as be Christmas motifs or the like.

The support comprises a motif that can be visually perceived in an outdoor environment, both during the day, only with natural light, with the lighting included in said support turned off, and at night, with the internal lighting on, which illuminates the motif from inside, highlighting the colors and letting the light out of the motif.

The invention falls within the industrial sector of structures that support decorative motifs, such as supports for Christmas, festive, fair-related, or advertising motifs, and more specifically in supports for this purpose, consisting of illuminated openworked cladding sheets.

### Description of Related Art

In the industrial sector of supports for decorative or advertising motifs, as well as those that can be used to decorate and/or illuminate environments during the holidays, such as Christmas, there is a large number of elements, components, configurations and systems intended both for fastening as well as for providing different types of decorations, depending on the motif to be displayed.

In recent years, research and development in this sector has been aimed at reducing the cost of the electrical energy required to illuminate such motifs, as well as limiting the light pollution generated during their use, while at the same time providing an attractive, ring-catching finish that is attractive to the user.

For example, in the case of decorative supports for advertising motifs, which can be hung from a structural element, such as a wall, the lighting may be intended to be prevented in a higher vertical direction, in order to prevent it from affecting the common development of the environment where these supports are installed.

On the other hand, a smaller number of lighting elements, such as light bulbs or LEDs, is also intended to be used in the sector to generate an appearance similar to the currently existing supports with decorative motifs, but with less electricity consumption, thereby reducing the electrical energy expenditure, especially in times of high consumption.

It is also an objective of the sector to reduce the costs of material, manufacturing, such as reducing the pollution generated during its manufacture, limiting the waste produced, extending the useful life of the manufactured product, reducing the generation of polluting gases.

Among the existing systems on the market, the one described in the document ES2646912B2 stands out, where a decorative and/or advertising support is defined for decorating outdoors at parties and events, as well as ES2639113A1, which describes improvements in said support, which can be used both indoors and outdoors. The problem with these systems is that the electricity consumption required to provide a suitable view of the subject for the user is very high, generating an excess of light pollution.

In this way, the main drawback that underlies supports known to be traditional is that of light pollution, requiring the user to reduce or adjust it so that the lighting is directed towards the subject itself, instead of illuminating an exterior that can generate a visual alteration of the environment, being as respectful as possible with the environment.

For this reason, the purpose of the support described below is to reduce this light pollution as well as to reduce the energy consumption required to display the supported motif.

### SUMMARY OF THE INVENTION

The present invention relates to a decorative support that is especially suitable for decorating or adorning outdoor urban spaces, as well as indoor spaces, replacing the conventional lighting decoration such as that used during the Christmas holidays.

Thus, the invention comprises a decorative motif support comprising:
two cladding sheets, which are preferably opaque, wherein at least one of said sheets comprises a through opening;
two intermediate layers each arranged overlapping an internal face of a cladding sheet, wherein at least one of said intermediate layers is enveloping, or covering, the at least one internal through opening of the cladding sheet with which it overlaps;
at least one attachment element configured to connect the two cladding sheets and the two intermediate layers in a single rigid framework which comprises a sandwich structure;
a lighting element located inside the rigid framework, between the two intermediate layers; and
a bead comprising an opaque section;
   wherein the bead occupies a section located in the space between the two intermediate layers, in a perimeter area of said intermediate layers, and wherein the opaque section of said bead is configured to block the passage of light generated by the lighting element from inside the framework to outside said framework; and wherein the lighting element is fixed to the framework by the at least one attachment element.

A through opening should be understood as a hole passing through a cladding sheet, in such a way that said sheets can have a frame configuration, and in other configurations, an openwork silhouette, that is, with a plurality of openings.

In the event that the cladding sheet comprises more than one through opening, the intermediate layer can cover all the openings, or only some of them.

Preferably, although it can be connected to the lighting element, the bead must be separated by a small distance to avoid possible heating.

Regarding the two cladding sheets included in the support, they are preferably flat, although in other embodiments they can be curved, depending on the needs and design criteria.

When said sheets are flat, one of the sheets can be referred to as the front and the other as the back, depending on the point of view from which the support is observed by the user, although, preferably, both sheets of the support are the same. That is, preferably, both comprise the same size, shape and thickness, also comprising the same design, with the same internal through opening or openings.

In another embodiment, and as indicated above, the cladding sheets can be curved, comprising the same center of curvature, so that one of the sheets must have a size (radius) somewhat smaller than the other for a proper fit of the framework to be suitable.

In a preferred embodiment, both sheets, regardless of their shape, are made of a rigid plastic material, specifically a biodegradable plastic material, especially suitable for providing structural support to the rest of the components of the support, resistant to external conditions where the support is installed.

In one embodiment, one or both of the cladding sheets comprise two or more openworks, consisting of a drawing based on perforations, openings or through holes, which form a design in said sheets. As these sheets are cladded or covered, internally, by a corresponding intermediate layer, and each of said intermediate layers may be colored with a drawing or decorative illustration, the assembly formed by the covering sheets with openwork, together with the colored intermediate layers, make up the decorative element of the support, which can be viewed with natural light or by means of the lighting element between the two intermediate layers of the support.

Preferably, both cladding sheets comprise the same openworks, and have a surface similar to the intermediate layers to which they are fixed, both intermediate layers having the same drawing, or the same illustration, so that the display of the decorative motif support is identical, both from the front and from the back.

The rigid framework formed by the cladding sheets and the intermediate layers, attached by at least one joining element, lacks a structural frame or skeleton like the one that the supports mentioned in the background had, since said frame was not necessary to form a rigid structure, thereby reducing the manufacturing cost as well as the generation of waste in said manufacturing and recycling of the support.

The fact that the framework is rigid means that its components are rigidly attached to one another, forming a single assembly or module that can be easily handled as a single piece, without implying that the framework is non-deformable when subjected to stress.

The opaque section of the bead, when said bead is located between the two intermediate layers, allows to greatly reduce, or completely avoid, the output of light generated by the lighting element towards the outside of the rigid framework, in an undesired direction, or in all directions, allowing said light to focus on illuminating the decorative motif, which greatly reduces the necessary electrical expenditure, compared to a support that does not include the opaque section of said bead.

For example, the opaque section of the beading can be partially positioned, such as in the upper middle area, to allow the output of light in some direction, such as downwards, or around the entire perimeter of the framework, to completely limit the output of light from inside the framework to the outside, other than to illuminate the decorative motif.

In the same way, in another embodiment, the bead can have, in addition to the opaque section, a section comprised of a transparent or translucent material, to allow the passage of the light beam generated by the lighting element towards the outside of the framework, in a specific area of said rigid framework, but providing the structural security provided by the bead inside the rigid framework, as it is located between the intermediate layers.

Preferably, the opaque section of the bead is only located in an upper middle area of the framework, to prevent the output of light in said direction, regardless of whether it occurs in other directions. In other words, the bead works as a cover, so that the incidence of the light generated by the lighting element is inwards, avoiding light pollution from the upper part of the motif, which is a great advantage over to supports described in the background.

The rigid framework, which comprises a sandwich structure, can have a flat rectangular basic shape if the cladding sheets are rectangular, but it can also have different shapes, depending on design conditions and needs. It may not even be flat if design conditions require it.

In one embodiment, the bead comprises at least one adjustable longitudinal cavity, preferably adjustable by clamping, to one of the cladding sheets. Preferably, said bead comprises two adjustable longitudinal cavities, also preferably adjustable by clamping, to each of the two cladding sheets of the frame, each of said cavities being located at opposite ends of the cross section; wherein said two longitudinal cavities are separated by a longitudinal channel where the lighting element is located.

Preferably, the lighting element(s) are mechanically fitted between the two cladding sheets, which avoids the need to use plastic zip ties. In other words, the fixing elements can be held by clamping or by other similar systems, between the two sheets.

In a preferred embodiment, the cladding sheet has an approximate thickness of 4 mm and is cut by a milling machine, which can also make the openwork.

In a preferred embodiment, at least one intermediate layer comprises a mesh configured to allow air to pass therethrough. In other words, given that the support can be installed outdoors, it is possible that a large amount of wind can affect said support and to avoid possible damage, these intermediate layers, which comprise or are made up of meshes, can allow said wind to flow therethrough, making the support especially suitable for outdoors in this embodiment.

These meshes can be made of metal or plastic as well as other materials suitable for the use described. They are preferably flexible and can be painted, colored or include a drawing that forms a design with the openings or openwork of the sheets. In other words, preferably, each of the meshes comprises a drawing or painted illustration which, combined with the openwork of the sheets, comprise the decorative motif.

In one embodiment, the support comprises a support means configured to fix the framework to an external structural element, such as a wall or a structural element such as a beam or post.

In a preferred embodiment, the support means comprises an upper profile, which is preferably metallic, at least two rigid rods, which are also preferably metallic, connected to the upper profile by an upper end part of said rigid rods and to the rigid framework by a lower end part.

In this way, only a small-sized profile is needed as a support to place (or hang) it where desired, and said upper profile can be, for example, a hollow, rectangular and elongated metal bar.

In one embodiment, the support comprises displacement means located on the upper profile, configured to displace the framework with respect to said upper profile in a longitudinal direction. This displacement means makes it easier for the user to transport the rigid framework and may comprise rolling elements such as wheels or bearings located in an upper part of the support.

In one embodiment, the support comprises at least one lifting ring connected to the upper profile, and is configured to fix the support to the outer structural element.

In one embodiment, the upper profile comprises a leveling element configured to check the horizontality or verticality of said upper profile, which facilitates its assembly for the user. In a preferred embodiment, said level contains water.

In another embodiment, the decorative motif support can comprise or form part of furniture or a structural element, such as a table or a window that includes a decorative motif. In other words, this support can be used as a table, if it is placed in a horizontal position, including bearing means, as well as an element for closing gaps, such as windows, since its configuration in the form of layers and sheets lends itself to this.

In one embodiment, the lighting element comprises a strip or band with a plurality of LEDs, and is arranged in a perimeter area of the space between the two intermediate layers. This LED strip can be guided by plastic spacers that are used to thicken the rigid framework.

In one embodiment, the support comprises a waterproof electrical connection box, wherein said waterproof box is connected to the lighting element. The electrical installation requires an electrical connection box for each support, which houses the connection of the light strip and its rectifier, and from which the power supply hose of the lighting element comes out. The inlets and outlets for cables in said watertight box are made through cable glands integrated in it, and in which the grounding connection attached to the metal profile is incorporated.

In a preferred embodiment, each of the cladding sheets is attached to a respective intermediate layer by means of a mechanical fixing element such as a clamp, tack, glue, etc., depending on the design, size of the element and its place of exposure.

Another part of the invention comprises a system comprising a plurality of rigid frameworks, as defined in the previous embodiments, wherein said frameworks are arranged to form a compact structure, as said frameworks are attached to each other. For example, said structure can form a tunnel with a set of curved frameworks, arranged for this purpose, or form a cube, with 6 flat frameworks arranged orthogonally.

The support described in the previous embodiments solves several problems that affect conventional indoor and outdoor decoration normally used at the holidays or on special occasions, in which a profile that is drawn with tubes, with or without filling, is used, where said filling is a string with LEDs in which, when illuminated, the light points of said LEDs shine, being designed for viewing exclusively at night, which is the only time they fulfill their decorative and entertaining function of the party or event. This conventional decoration has the following drawbacks:
It only works at night, offering a blurred and non-decorative view during the day.
It does not allow much decorative and chromatic play even when illuminated, since the luminous tubes making up the figures do not offer as many possibilities for decoration as the intermediate layer, which can be painted like an oil painting, although without covering the grid to let the wind pass, and as for the color, it is necessary to stick to the basic colors of the LEDs, without allowing the color palette that the invention admits.

Given that the support can comprise a mesh next to the opening or the openwork of the sheets, this mesh offers, on the one hand, the possibility of painting it as one can paint an oil painting, with the only exception of leaving the pores of the mesh so that the wind can flow and thus compensate for its resistance to the wind, that is, it lends itself to a more complete decoration while at the same time not offering resistance to the wind.
Due to the lightness of the materials, it is appropriate to hang it on streets and in squares, without reducing its resistance.
Unlike conventional luminous exterior decorations, which hardly offer a range of colors but rather stick to the basics, that is, to the colors of the LEDs, the invention described offers the possibility of choosing any color, even allowing the degradation and fusion of colors, acting as a canvas where you can paint artistically or even use a printer to transfer the graphic.
Since the LEDs can be fixed to the edge of the framework and oriented towards the mesh, the mesh is lit up at night with the full intensity and reflection of the LEDs, being bathed in light.
During the day, without internal lighting, the decoration is shown in all its chromatic and graphic richness, with the only imperceptible handicap being that the porous part of the mesh remains unpainted, which does not diminish its decorative function.
Compared to the juxtaposition of LED lamps to form the filling of the figures that the conventional embodiment carries out, the described invention advantageously solves the filling of said figures by including the mesh, with the consequent saving of electrical material and manpower since that cumbersome installation in which the LED string must be restrained with zip ties, arranging its corresponding electrical connections, is not necessary.
This same invention can serve as an advertising support.

### BRIEF DESCRIPTION OF THE DRAWINGS

The terms Fig., Figs., Figure, and Figures are used interchangeably in the specification to refer to the corresponding figures in the drawings.

To complement the following description and for the purpose of helping to better understand the features of the invention, a set of drawings is attached to the present specification, in the figures of which, by illustration and not limitation, the most characteristic details of the invention are represented.

FIG. 1 shows a perspective view of the support with a decorative motif, with the framework shown in an exploded view, wherein the rigid cladding sheets are flat, frame-shaped, and the intermediate layers each comprise a mesh forming the rectangular sandwich structure, and each of the components of said support as well as the preferred arrangement thereof can be seen. By means of this embodiment, the meshes can comprise a painted motif that is shown to the user with illumination when the lighting element is turned on, since the cladding sheets have the shape of a rectangular frame.

FIGS. 2A and 2B show two perspective views of respective examples of the decorative motif support. The one shown in FIG. 2A comprises one of rectangular or rhomboid shape, the cladding sheets comprising a central through opening, and in the one shown in FIG. 2B said sheets comprising an irregular rectangular shape, with three through openings.

FIG. 3 shows a view of a section of the bead connected to the two cladding sheets by means of two channels located at the transverse ends of said bead, said channels being adjusted to the sheets, the lighting element being located in the space between them.

FIG. 4A shows a diagram of an illumination measurement test of a decorative motif support existing in the sector, such as those defined in the background. That is, a light motif, such as with Christmas lights, made up solely of a tube filled with a strip of LEDs, without elements such as cladding sheets or beads.

FIG. 4B shows a diagram of the same lighting measurement test as the one carried out and shown in FIG. 3A, both motifs having the same size and graphic design, but with a decorative motif support as described in independent claim 1. That is, it comprises two cladding sheets with an openwork in same, two intermediate layers in the form of meshes, and a light-generating element between both meshes.

### LIST OF REFERENCE NUMBERS SHOWN IN THE FIGURES

1.—Cladding sheet
2.—Intermediate layer
3.—Lighting element
4.—Rigid rod
5.—Upper profile
6.—Ring
7.—Leveling element
8.—Connection box
9.—Reed
91.—Adjustable longitudinal cavity
92.—Central longitudinal channel
93.—Opaque section
94.—Transparent or translucent section
10.—Attachment element
11.—Light beam

### DESCRIPTION OF THE INVENTION

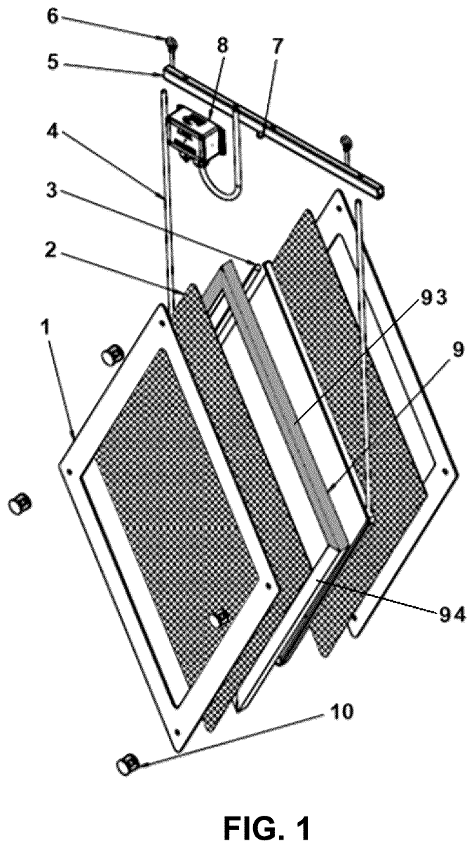

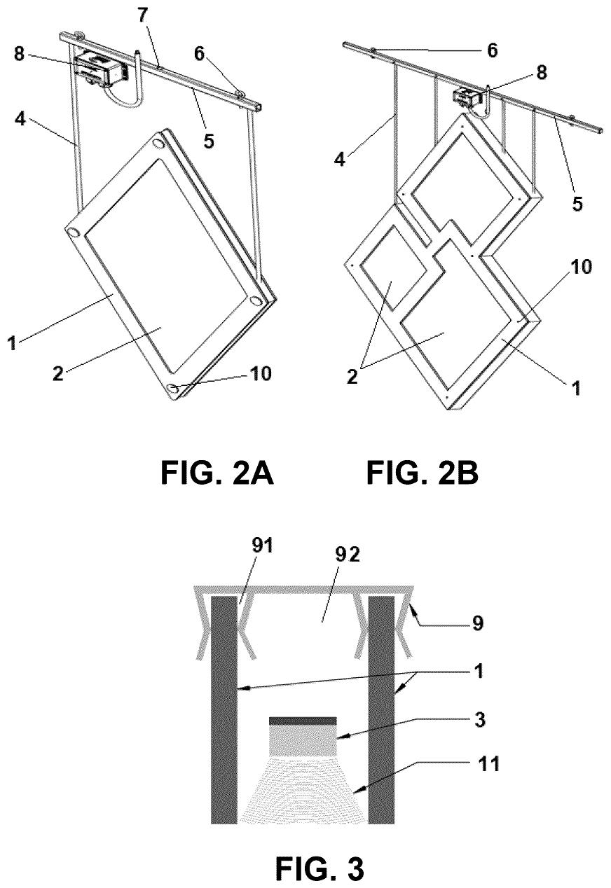

As can be interpreted from the figures, especially FIGS. 1 and 2, the preferred invention consists of a decorative motif support comprising a rigid framework, which in turn comprises two flat cladding sheets (1), located on the sides opposite sides of the framework, wherein each of said cladding sheets (1) has at least one internal through opening. However, in another embodiment, said cladding sheets (1) have openwork consisting of a plurality of perforations or through openings that form a decorative structure.

In addition to the cladding sheets (1), the rigid framework comprises two translucent intermediate layers (2), preferably in the form of meshes, each one of them attached to one of the cladding sheets (1) on an inner surface of said sheets (1), covering the at least one internal through opening of the cladding sheets (1).

These intermediate layers (2) may comprise a drawing or a painting that may or may not be combined with the openwork of the cladding sheets (1), so that, either individually or in combination, they form a decorative motif.

To fix or connect said parts, the framework comprises at least one attachment element (10) that connects the two cladding sheets (1) and the two intermediate layers (2) in a single assembly that forms the rigid framework, with one element lighting (3) in the form of a strip of LEDs between the two intermediate layers (2), fixed to the cladding sheets (1) together with a bead (9).

As can be seen in FIG. 1, the bead (9) comprises an opaque section (93) (represented in said FIG. 1 by a gray color) located only in an upper middle area or perimeter of the rigid framework, between the two meshes, for the purpose of blocking the output of light generated by the lighting element (3) from an internal area of the framework only towards the upper exterior of said framework. In this way, and preferably, that opaque section (93) of the bead (9) causes the light generated to be directed towards the decorative motif and towards a lower outer part of the framework, thereby reducing light pollution and improving energy efficiency by directing the light towards the desired designed area. As can also be seen in said FIG. 1, the bead (9) comprises a transparent or translucent section (94) in a lower part which provides structural security to the support but allows the output of light from the inside to the outside of the framework.

As can be seen in FIGS. 2A and 2B, the compact rigid framework comprises a symmetrical sandwich structure, with the lighting element (3) in the center, located in the space between the two intermediate layers (2) in the form of meshes, in an inner area of the rigid framework, wherein the two meshes are each arranged on an inner surface, on each side of the lighting element (3).

As a result of the meshes, a decorative design can be displayed as if it were an illuminated canvas which is not affected by the wind. In other words, the decorative support can be placed outdoors, and in the event that there is a wind that affects the rigid framework perpendicularly, this wind can pass through the opening or openings of the cladding sheets (1) as well as the meshes themselves that are drawn on or colored.

These meshes are preferably made of a metallic material to provide suitable structural stability to the defined framework, although they can be made of other light materials that are resistant to the bad weather to which they may be subjected outdoors. They comprise a mesh density suitable for the purpose described. That is, it allows air to pass therethrough, without hindering its passage.

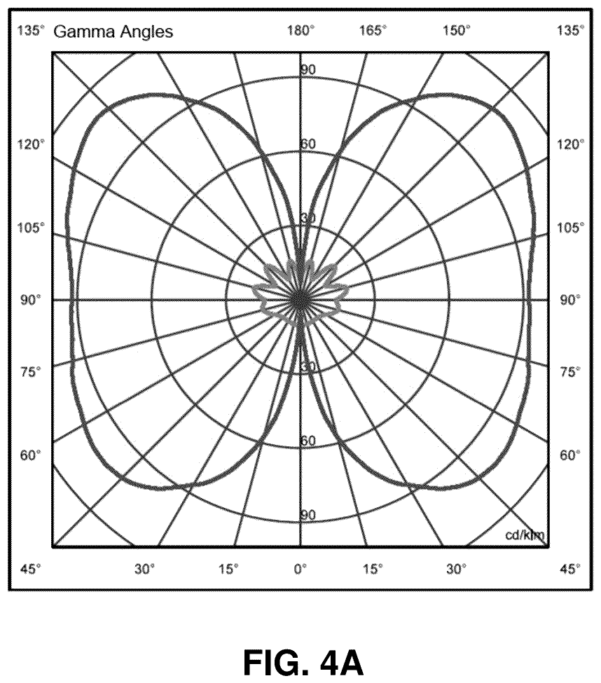

FIG. 3 shows an embodiment of the configuration of a bead (9). As can be seen from said FIG. 3, the bead (9) is not in direct contact with the lighting element (3) since overheating can affect the characteristics of the bead (9). This bead (9), either in its opaque section (93) or in its transparent or translucent section (94), has a U-shaped cross section comprising two adjustable longitudinal cavities (91) which are adjustable by clamping, to each of the two cladding sheets (1) of the framework, and are separated by a central longitudinal channel (92) where the lighting element (3) is located.

FIG. 3 also shows the direction of the light beam (11) generated by the lighting element (3) towards the inside of the rigid framework, in a lower direction, and the position of the bead (9) preventing the output of said beam (11) in an upward or upper direction.

To fix the decorative motif support to an outdoor structural element, such as a wall, beam, or even a cable, this support comprises a support means that comprises an upper metal profile (5) and at least two rigid rods (4) which are also metallic. In FIGS. 1 and 2 it can be seen that the rods (4) are connected to the upper profile (5) by an upper end portion of said rigid rods (4) and to the rigid framework by a lower end portion. Specifically, the rigid rods (4) are connected to the attachment elements of the framework.

The upper profile (5) is connected to a pair of lifting rings (6) which allow the fixing of the frame support to the outdoor structural element by means of mechanical elements. In order for said upper profile (5) to be well leveled, it comprises a leveling element (7) containing water, which allows the user to ensure its horizontal position.

As the decorative motif support comprises an electrical consumption element, such as the lighting element (3) based on a strip of LEDs, and as it is suitable for installation outdoors, the support also comprises a waterproof electrical connection box (8) for the electrical connection to the lighting element (3), which allows powering and controlling the electronic operation of each support individually in the event that there is more than one support connected to others.

As shown in FIGS. 5A and 5B, the rigid frameworks can be arranged in different ways to form a compact structure, said frameworks being rigidly attached by fixing means.

Given that the shape and composition of the rigid frameworks allow it, since they can comprise both flat and curved cladding sheets, a plurality of frameworks can comprise a system having different shapes, comprising a structure of rigidly fixed frameworks.

### Tests

The following section shows two tests carried out on two decorative motif supports that comprise a similar graphic design, as well as the same size, but different elements. The first of these tests has been carried out on a support with a traditional configuration. That is, a support that includes a conduit containing LED strips therein in such a way that said conduit forms a decorative figure, such as a reindeer or a Christmas tree. The second test has been carried out on a support as described in the first claim, which comprises the two cladding sheets, two intermediate layers in the form of mesh, a bead with an opaque section located in an upper part of the framework, and a lighting element located between the two meshes.

The following diagrams and tables specify the savings in terms of light pollution and electrical consumption:

| | Test 1: | | | |
|---|---|---|---|---|
| | Traditional | Test 2: | Reduction | Reduction |
| | motif | New motif | in Im | in % |
| Electric power | 65.7 | 32.15 | | 50-70 |
| FHS (Light | 2209 | 166 | 2044 | 92.5% |
| Pollution) | | | | |
| (Lumens) | | | | |

The test has been carried out according to UNE-EN 13032-4:2016+A1:2020 Light and lighting standard. Measurement and presentation of photometric data of lamps and luminaires in a photometric tunnel with calibrated instruments, according to an ISO 17025 quality system

As can be interpreted from the table above, the new motif entails energy savings of over 50% compared to the traditional motif, as well as an improvement of more than 92% in the FHS factor relative to the light pollution it projects.

In other words, once the tests of these two motifs have been analysed, both having a similar size and graphic design, it can be concluded that the electrical consumption of the new motif is between 50-70% less than that of the traditional motif. This is due to the fact that the traditional motif comprises a higher concentration of LEDs so that it can be viewed by the user, while the claimed support requires fewer LEDs to show the included motif.

The same occurs in relation to light pollution, since it can be seen that the claimed support generates between 90-95% less pollution than the traditional motif. For practical purposes, it is concluded that the new motif is therefore much more energy efficient and more respectful of the night environment than the traditional one.

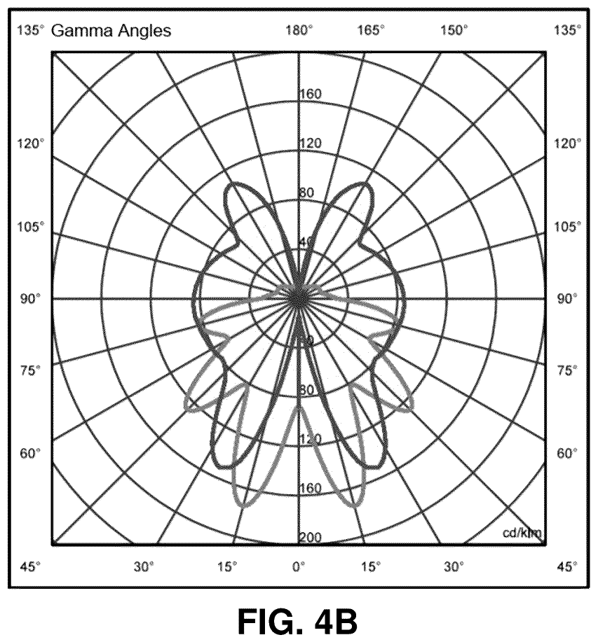

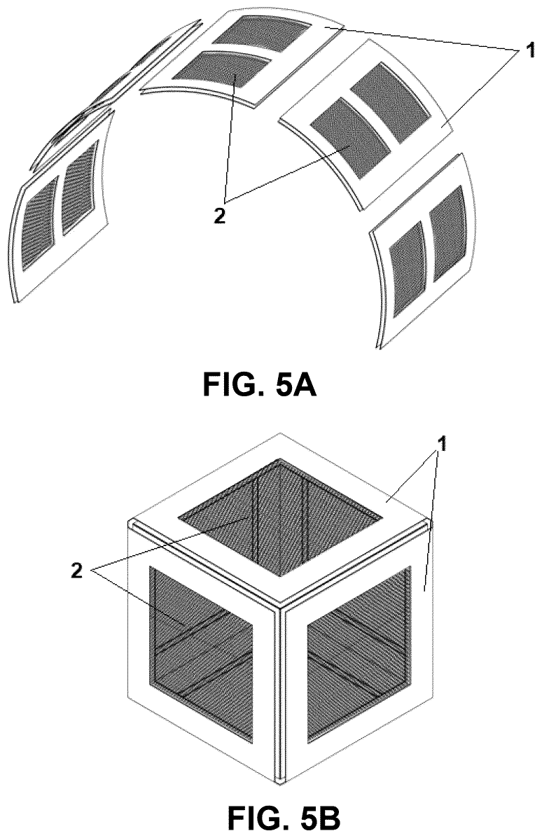

FIGS. 4A and 4B show a diagram of the light scattering of test 1 (FIG. 4A) and test 2 (FIG. 4B). It can be seen from said diagrams that the described configuration of the claimed motif generates a much lower light scattering than in test 1.

This allows a smaller amount of electrical energy to be necessary to generate a similar lighting effect in the claimed support than in the existing one, with the advantage that this entails.

1. A decorative motif support comprising:
two cladding sheets, wherein at least one of said cladding sheets comprises an internal through opening;
two intermediate layers each arranged overlapping an internal face of a cladding sheet, wherein at least one of said intermediate layers is enveloping the at least one internal through opening of the cladding sheet with which it overlaps;
at least one attachment element configured to connect the two cladding sheets and the two intermediate layers in a single rigid framework comprising a sandwich structure; and
a lighting element located inside the rigid framework, between the two intermediate layers;
wherein the support comprises:
a bead comprising an opaque section
wherein the bead occupies a section located in the space between the two intermediate layers, in a perimeter area of said intermediate layers, and wherein the opaque section of said bead is configured to block the passage of light generated by the lighting element from inside the framework to outside said framework; and
wherein the lighting element is fixed to the framework by the at least one attachment element.

2. The decorative motif support according to claim 1, wherein the bead comprises a transparent or translucent section, in addition to the opaque section.

3. The decorative motif support according to claim 1, wherein the opaque section of the bead is located in an upper middle part of the framework.

4. The decorative motif support according to claim 1, wherein the bead comprises at least one adjustable longitudinal cavity, preferably adjustable by clamping, to one of the cladding sheets.

5. The decorative motif support according to claim 4, wherein the bead comprises two adjustable longitudinal cavities, preferably adjustable by clamping, to each of the two cladding sheets of the framework, each of said cavities being located at opposite ends of the cross section; wherein said two longitudinal cavities are separated by a central longitudinal channel where the lighting element is located.

6. The decorative motif support according to claim 1, wherein at least one of the cladding sheets comprises two or more openworks covered by the corresponding intermediate layer.

7. The decorative motif support according to claim 1, wherein at least one intermediate layer comprises a mesh configured to allow air to pass therethrough.

8. The decorative motif support according to claim 1, wherein each of the meshes comprises a painted decorative motif.

9. The decorative motif support according to claim 1, comprising a support means configured to fix the framework to an external structural element.

10. The decorative motif support according to claim 9, wherein the support means comprises an upper profile, which is preferably metallic, at least two rigid rods, which are also preferably metallic, connected to the upper profile by an upper end part of said rigid rods and to the rigid framework by a lower end part.

11. The decorative motif support according to claim 10, comprising at least one lifting ring connected to the upper profile, and configured to fix the support to the external structural element.

12. The decorative motif support according to claim 1, wherein the lighting element comprises a strip comprising a plurality of LEDs, and is arranged in a perimeter area of the space between the two intermediate layers.

13. The decorative motif support according to claim 1, comprising a watertight box for electrical connection, said watertight box being connected to the lighting element.

14. A system comprising a plurality of rigid frameworks as defined in claim 1, wherein said frameworks are arranged to form a compact structure, as said frameworks are attached together.
